(19) United States
(12) Patent Application Publication
(10) Pub. No.: US 2006/0125213 A1
(43) Pub. Date: Jun. 15, 2006

(54) Air-bag

(76) Inventor: Dion Kruse, Alingsas (SE)

Correspondence Address: BRINKS HOFER GILSON & LIONE, P.O. BOX 10395, CHICAGO, IL, 60610, US

(21) Appl. No.: 10/528,162

(22) PCT Filed: Jun. 4, 2003
(86) PCT No.: PCT/SE03/00908

§ 371 Date: Oct. 26, 2005

(30) Foreign Application Priority Data
Sep. 20, 2002 (GB) 0221921.0

(51) Int. Cl. B60R 21/213; B60R 21/23

(52) U.S. Cl. 280/730.2; 280/743.1; 280/743.2

(57) ABSTRACT

An air-bag is disclosed for mounting in a motor vehicle (2). The air-bag takes the form of an inflatable curtain (1) and is arranged to be mounted in position above a side window opening (5, 6) in the vehicle. The inflatable curtain (1) is configured so that, when inflated, at least two-thirds of its lower-most edge (18, 19) extends beneath the lower-most edge (8, 9) of the or each adjacent window (6, 7). The inflatable curtain (1) defines a plurality of discrete inflatable cells (23, 24, 25).

### CROSS REFERENCE TO RELATED APPLICATION

This application claims priority to PCT/SE2003/000908, filed Jun. 4, 2003 and GB 0221921.0, filed Sep. 20, 2002.

### FIELD OF THE INVENTION

The present invention relates to an air-bag, and more particularly relates to an air-bag in the form of an inflatable curtain.

### BACKGROUND AND SUMMARY OF THE INVENTION

It has been proposed previously to provide an air-bag safety device for a motor vehicle, the safety device being in the form of an inflatable curtain which, when inflated, extends from the roof-line of the vehicle adjacent the side windows of the vehicle to provide protection for an occupant of the vehicle during a side impact or roll-over situation.

Many different designs of inflatable curtain have been proposed in recent years.

Some prior proposed inflatable curtains extend to cover only the top part of the side windows, primarily to prevent the head of a vehicle occupant from being displaced to such an extent that the head of the occupant is on the outside of the vehicle during a side impact or roll-over situation. However, it has been found that in some situations the limbs of a vehicle occupant, such as the arms of the occupant, may extend through the side windows during a roll-over situation, with such an inflatable curtain arrangement.

The present invention seeks to provide an improved air-bag in the form of an inflatable curtain.

According to the present invention, there is provided an air-bag mounted in a motor vehicle, the motor vehicle having at least one window opening with a lower edge, the air-bag being mounted in position above the window opening and being configured so that, when inflated, at least two-thirds of the lower-most edge of the air-bag extends beneath the lower-most edge of the window, the air-bag defining a plurality of inflatable cells.

Preferably when inflated, the degree of overlap of the lower edge of the inflatable element, and the part of the vehicle beneath the lower-most edge of the window opening is between 40 and 100 millimetres. Advantageously the degree of overlap is between 50 and 60 millimetres.

Conveniently a forward part of the air-bag is secured to the vehicle at a first anchoring point and a rear part of the air-bag is secured to the vehicle at a second anchoring point, the inflatable cells being configured so that a virtual line of tension is created between the anchoring points when the air-bag is inflated. Preferably the inflatable cells are configured so that the axis of each cell is substantially perpendicular to the line of tension at least beneath the line of tension. Advantageously a tensioning unit is provided at one of said anchoring points.

Conveniently the tensioning unit of the air-bag is a strap extending from an inflatable region of the air-bag to the tensioning unit.

Preferably the air-bag is provided with a re-entrant slot in the lower edge thereof, the slot being substantially in alignment with one structural post of the vehicle.

In order that the invention may be more readily understood, and so that further features thereof may be appreciated, the invention will now be described, by way of example, with reference to the accompanying drawings in which:

### BRIEF DESCRIPTION OF THE DRAWINGS

FIG. 1 is a diagrammatic view of a first embodiment of an air-bag in accordance with the invention when in the inflated condition, and

FIG. 2 is a corresponding view illustrating an alternative form of air-bag in accordance with the invention.

### DETAILED DESCRIPTION OF THE DRAWINGS

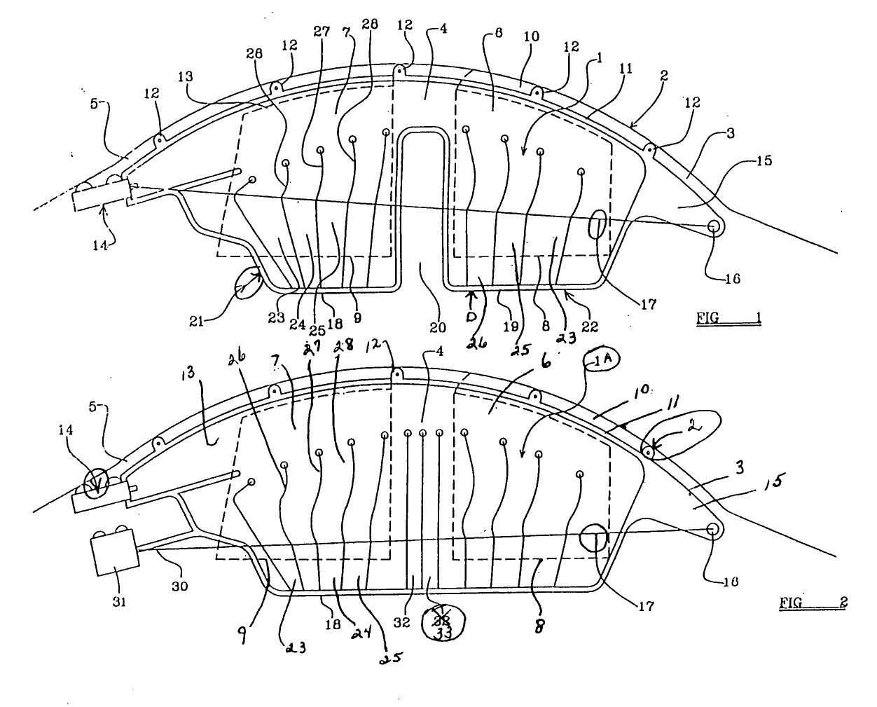

Referring initially to FIG. 1, an air-bag in the form of an inflatable curtain 1 is illustrated. The inflatable curtain 1 is illustrated mounted within a motor vehicle 2. The motor vehicle 2 is provided with a structural “A”-Post 3 extending towards the front of the vehicle, a structural “B”-Post 4 located in the centre of the vehicle between the front and rear side windows, and a structural “C”-Post 5 located towards the rear of the vehicle. Two side windows 6, 7 are mounted in the vehicle, the front window 6 having a lower edge 8, and the rear window 7 having a lower edge 9. The lower edges 8, 9 of the windows 6, 7 are co-aligned and, in the illustrated embodiment, are substantially horizontal.

The vehicle 2 has a roof-line 10 which extends from the “A”-Post 3 at the front of the vehicle, across the top of the “B”-Post 4 to the “C”-Post 5 at the rear of the vehicle.

The inflatable curtain 1 is formed from two superimposed layers of fabric which are secured together around their co-aligned outer edges, and which are also secured together in other regions to define, as will become clear from the following description, a plurality of discrete inflatable chambers.

The inflatable curtain 1 has an upper edge 11 provided with mounting lugs 12, the upper edge 11 being configured so that the mounting lugs 12 may be connected to mounting brackets provided in the roof-line 10 of the vehicle. An open gas-flow path 13 is defined within the inflatable curtain 1 adjacent the upper edge 11. Optionally a gas supply duct may be provided within this gas-flow path 13, but no separate gas supply duct is illustrated in this embodiment.

A gas generator 14 is provided which is mounted on the “C”-Post 5 of the vehicle 2 and is positioned to inject gas into the gas-flow path 13 of the inflatable curtain 1. The gas generator 14 is securely mounted in position and constitutes an anchoring point that is located at one end of a virtual line of tension that exists when the inflatable curtain has been inflated.

At the forward end of the motor vehicle the inflatable curtain 1 is provided with a forwardly extending lug 15 provided with a terminal anchoring point 16 which connects the lug 15 to the “A”-Post 3. The anchoring point 16 constitutes an anchoring point at the other end of the virtual line of tension.

The line of tension is shown as line 17. This is purely a “notional” line, and would not in any way be visible in reality.

The inflatable curtain 1 has a lower edge constituted by two-edge regions 18, 19 which are separated from one another by a re-entrant slot 20 which extends upwardly from the lower edge in the region of the “B”-Post 4 to accommodate a “B”-Post mounted safety-belt (not shown). The two lower-edge regions 18, 19 are each located at a position beneath the lower-most edges 8, 9 of the windows 6, 7 of the motor vehicle 2. The overlap distance “D” between the lower edge regions 18, 19 of the inflatable curtain and the lower-most edges of the adjacent windows should be between 40 and 100 millimetres, and most preferably between 50 and 60 millimetres.

The re-entrant slot 20 in the region of the “B”-Post 4 effectively divides the inflatable curtain 1 into two inflatable areas 21, 22, with each area being divided into a plurality of separate inflatable cells, such as the cells 23, 24, 25, by means of separating seams, such as the seams 26, 27, 28. In the illustrated embodiment the seams which define the inflatable cells, such as the seams 26, 27, 28, extend to the lower edge regions 18, 19 of the inflatable curtain 1 so that the cells are effectively “sealed” at their lower-most ends. However, in an alternative embodiment of the invention, the seams, such as the seams 26, 27, 28, which define the cells may terminate at a point above the lower edge regions 18, 19 of the inflatable curtain 1, so that there is internal venting between adjacent cells.

It is to be observed that the nature of the separating seams 26, 27, and 28 is such that, at least below the line of tension 17, the axis of each cell 23, 24, 25 is substantially perpendicular to the line of tension 17.

It is to be appreciated that before deployment, the inflatable curtain 1 is folded and stored within a housing or channel formed in the roof-line 10 of the vehicle 2, so that the inflatable curtain may be inconspicuous. On deployment of the inflatable curtain 1, in response to a signal from an appropriate sensor, gas will be generated by the gas generator 14 and will flow through the gas-flow path 13 to inflate the discrete inflatable cells, such as the cells 23, 24, 25 in each of the inflatable areas 21 and 22 of the inflatable curtain 1. As the cells inflate, so the effective width of the inflatable areas 21 and 22 in the region extending between the anchoring point securing the gas generator 14 in position, and the anchoring point 16 securing the forwardly extending lug 15 in position will reduce, thus creating the line of tension 17.

Because a substantial proportion of the lower-most edges 18, 19 of the inflatable areas 21 and 22 extends beneath the lower-most edges 8, 9 of the adjacent window openings, the windows 6, 7 are completely, or at least substantially covered by the inflatable curtain 1, thus minimising the risk of any part of an occupant being ejected through the window during an accident situation. It has been found that the minimum tractable extent of “overlap” D of the inflatable curtain, and the part of the vehicle below the lower-most edge of the side window should be approximately 40 millimetres, to provide an appropriate degree of support. A degree of overlap of greater than 100 millimetres may prove to be undesirable, as the inflatable curtain has to be inflated swiftly if it is to provide the desired protective effect, especially in a side impact situation, and any increase in overlap increases the volume of the cells in the inflatable areas, meaning that more gas must be provided to inflate the inflatable curtain, thereby slowing the time to reach full deployment.

The re-entrant slot 20 is provided so that the inflatable curtain may deploy in the desired manner in a motor vehicle in which safety-belts are provided which are mounted on the “B”-Posts at either side of the vehicle. The re-entrant slot 20 does not substantially reduce the effect of the notional line of tension 17. Each of the inflatable areas 21, 22, because of the presence of the discrete cells, will have a certain degree of rigidity when inflated. With each inflatable area 21, 22 having its upper-most edge secured to the roof of the vehicle, and having its lower edge overlapping with the part of the vehicle beneath the adjacent side window, with at least one side edge being secured in position by the anchoring point at the appropriate end of the notional line of tension 17, the described parts of the inflatable curtain will remain in their intended position during a typical side impact or roll-over situation, providing the desired degree of protection for a vehicle occupant.

It is to be noted that the cells, as exemplified by the cells 23, 24, 25, may have a more “stylistic” or contoured configuration at points above the notional line of tension 17.

It is preferred that the extent of the lower edges 18 and 19 of the inflatable curtain 1, which is overlapped beneath the lower edges 8 and 9 of the adjacent window should be at least two-thirds of the total length of lower edges of the inflatable curtain.

FIG. 2 illustrates a modified embodiment of the invention in which like reference numerals are used to indicate like parts. However, this embodiment of the invention is intended for use in a motor vehicle where instead of the safety-belt being mounted on the “B”-Post of the vehicle, the safety-belt is totally integrated within the seat of the vehicle. Consequently, in this embodiment there is no re-entrant slot equivalent to the slot 20 of the embodiment illustrated in FIG. 1, because no access is required to the “B”-Post through the inflatable curtain. Thus the lower edge of the inflatable curtain 1A is a single integral lower edge 18A. Although the gas generator 14 is secured to the “C”-Post 5, as in the proceeding embodiment, in the embodiment of FIG. 2 at a point beneath the gas generator 14, the inflatable curtain 1A is provided with an extending strap 30 which is connected to a tensioning unit 31. The tensioning unit 31 is configured to apply tension to the strap 30 as the inflatable curtain is inflating, thus establishing a substantially horizontal line of tension extending between the tensioning unit 31 and the anchoring point 16. The remaining features of the embodiment of FIG. 2 correspond directly with the corresponding features of the embodiment of FIG. 1 as described above, save that, in the illustrated embodiment, cells 32, 33 are provided which are co-aligned with the “B”-Post 4 of the vehicle, those cells having a volume which is much smaller than the volume of the remaining cells present in the inflatable curtain. Thus the cells only require a minimum amount of gas to become inflated, but still serve to provide protection in the region of the “B”-Post. Thus the cells may provide some protection should the head of an occupant of the vehicle move in such a way that the head may strike the “B”-Post 4 of the vehicle.

Whilst the described embodiments of the invention comprise inflatable curtains formed primarily from two adjacent layers of fabric, it is to be understood that in alternative embodiments of the invention, three or more layers of fabric may be provided to improve the degree of support provided by the inflatable curtain when the inflatable curtain is inflated. If three or more layers of fabric are utilised, the three layers will be super-imposed with one set of cells being defined between the central layer of fabric and one outer layer of fabric, and a second set of cells, off-set from the first set, being defined between the central layer of fabric and the other outer layer of fabric.

While the above description constitutes the preferred embodiment of the present invention, it will be appreciated that the invention is susceptible to modification, variation and change without departing from the proper scope and fair meaning of the accompanying claims.

1. An inflatable curtain air-bag mounted in a motor vehicle, the motor vehicle having at least one side window opening with a lower edge comprising, the inflatable curtain being mounted in position above the window opening and defining a lower edge region and being configured so that, when inflated, at least two-thirds of the lower edge region of the inflatable curtain extends beneath the lower edge of the window opening, the inflatable curtain defining a plurality of inflatable cells.

2. An inflatable curtain according to claim 1 wherein, when inflated, the degree of overlap of the lower edge region of the inflatable curtain, and the window opening lower edge is between 40 and 100 millimetres.

3. An inflatable curtain according to claim 1 wherein when inflated the degree of overlap of the lower edge region of the inflatable curtain and the window opening lower edge is between 50 and 60 millimetres.

4. An inflatable curtain according to claim 1 wherein a forward part of the inflatable curtain is secured to the vehicle at a first anchoring point and a rear part of the inflatable curtain is secured to the vehicle at a second anchoring point, the inflatable cells being configured so that a virtual line of tension is created between the anchoring points when the inflatable curtain is inflated.

5. An inflatable curtain according to claim 4 wherein the inflatable cells are configured so that the longitudinal axis of each cell is substantially perpendicular to the line of tension at least beneath the line of tension.

6. An inflatable curtain according to claim 4 wherein a tensioning unit is provided at one of the anchoring points to apply tension to part of the inflatable curtain.

7. An inflatable curtain according to claim 6 wherein the said part of the inflatable curtain is a strap extending from an inflatable region of the inflatable curtain to the tensioning unit.

8. An inflatable curtain according to claim 1 wherein the inflatable curtain further forms a re-entrant slot in the lower edge thereof, the slot being substantially in alignment with a structural post of the vehicle.

9. An inflatable curtain air-bag mounted in a motor vehicle, the motor vehicle having at least one side window opening with a lower edge comprising, the inflatable curtain being mounted in a position above the window opening and defiing a lower edge regaon being configured so that, when inflated, the lower edge region of the inflatable curtain extends beneath the lower edge of the window opening, the inflatable curtain defining a plurality of inflatable cells.

10. An inflatable curtain according to claim 9 wherein, when inflated, the degree of overlap of the lower edge region of the inflatable curtain, and the window opening lower edge is between 40 and 100 millimetres.

11. An inflatable curtain according to claim 9 wherein when inflated the degree of overlap of the lower edge region of the inflatable curtain and the window opening lower edge is between 50 and 60 millimetres.

12. An inflatable curtain according to claim 9 wherein a forward part of the inflatable curtain is secured to the vehicle at a first anchoring point and a rear part of the inflatable curtain is secured to the vehicle at a second anchoring point, the inflatable cells being configured so that a virtual line of tension is created between the anchoring points when the inflatable curtain is inflated.

13. An inflatable curtain according to claim 12 wherein the inflatable cells are configured so that the longitudinal axis of each cell is substantially perpendicular to the line of tension at least beneath the line of tension.

14. An inflatable curtain according to claim 12 wherein a tensioning unit is provided at one of the anchoring points to apply tension to part of the inflatable curtain.

15. An inflatable curtain according to claim 14 wherein part of the inflatable curtain is a strap extending from an inflatable region of the inflatable curtain to the tensioning unit.

16. An inflatable curtain according to claim 9 wherein the inflatable curtain further forms a re-entrant slot in the lower edge thereof, the slot being substantially in alignment with a structural post of the vehicle.
